(19) United States
(12) Patent Application Publication
(10) Pub. No.: US 2010/0285300 A1
(43) Pub. Date: Nov. 11, 2010

(54) Nano-materials

(75) Inventors: Jia-Ping Wang, Beijing (CN); Kai-Li Jiang, Beijing (CN); Qun-Qing Li, Beijing (CN); Shou-Shan Fan, Beijing (CN)

Correspondence Address: Altis Law Group, Inc.;ATTN: Steven Reiss, 288 SOUTH MAYO AVENUE, CITY OF INDUSTRY, CA, 91789, US

(73) Assignees: Tsinghua University, Beijing (CN); HON HAI PRECISION INDUSTRY CO., LTD., Tu-Cheng (TW)

(21) Appl. No.: 12/589,493

(22) Filed: Oct. 23, 2009

(30) Foreign Application Priority Data
May 8, 2009 (CN) 200910107299.X

(51) Int. Cl. B32B 3/26; B32B 9/00; B32B 5/16; B32B 5/00

(52) U.S. Cl. 428/315.5; 428/408; 428/323; 428/221

(57) ABSTRACT

A nano-material includes a free-standing carbon nanotube structure and a number of nano-particles. The carbon nanotube structure includes a number of carbon nanotubes. The nano-particles are successively and closely linked to each other and coated on a surface of each of the carbon nanotubes of the carbon nanotube structure.

### RELATED APPLICATIONS

This application claims all benefits accruing under 35 U.S.C. §119 from China Patent Application No. 200910107299.X, filed on May 8, 2009 in the China Intellectual Property Office. This application is related to applications entitled “COMPOSITE MATERIAL,” filed ______ (Atty. Docket No. US24862); “METHOD FOR MAKING NANOWIRE STRUCTURE,” filed ______ (Atty. Docket No. US21323); “METHOD FOR MAKING COMPOSITE MATERIAL,” filed ______ (Atty. Docket No. US28706); “CARBON NANOTUBE COMPOSITE AND METHOD FOR FABRICATING THE SAME,” filed on Aug. 13, 2009 (Atty. Docket No. US20920).

### BACKGROUND

1. Technical Field

The disclosure relates to materials, and particularly to a nano-material.

2. Description of Related Art

Methods have been developed to manufacture nano-materials, including spontaneous growth, template-based synthesis, electrospinning, and lithography. However, the nano-materials made by these methods are not of a uniform structure because the nano-particles in the materials tend to agglomerate during manufacture.

Additionally, the following example illustrates other problems. A titanium dioxide nanofiber can be fabricated via an electro-spinning method. A mixture of titanium-tetraisopropoxide (TTIP) and poly vinylpyrrolidone (PVP) in an alcohol medium utilized as a sol-gel solution is injected through a needle under a strong electrical field. Composite titanium dioxide nanofiber made of PVP and amorphous titanium dioxide form (with lengths up to several centimeters) as a result of electro-spinning. Both supported and free-standing mats consist of titanium dioxide nanofiber. However, the electro-spinning method for fabricating titanium dioxide nanofibers requires high voltage, which is costly, and requires complicated equipment to carry out. Furthermore, the titanium dioxide nanofibers made by the electro-spinning method are disorderly distributed.

Thus, it is desired to provide a new nano-material which includes a plurality of nanowires substantially aligned along one preferred orientation.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout several views.

FIG. 1 is a schematic view of a first embodiment of a nano-material.

FIG. 2 shows a Scanning Electron Microscope (SEM) image of a drawn carbon nanotube film.

FIG. 3 is a schematic structural view of a carbon nanotube segment of the drawn carbon nanotube film of FIG. 2.

FIG. 4 is a process flow chart of one embodiment of a method for fabricating the carbon nanotube composite material of FIG. 1.

FIG. 5 is an SEM image of the drawn carbon nanotube film of FIG. 2 having titanium deposited thereon.

FIG. 6 is an SEM image of the first embodiment of a nano-material.

FIG. 7 is a Transmission Electron Microscopy (TEM) image of titanium dioxide nanowires in the nano-material of FIG. 6.

FIG. 8 is a schematic view of a second embodiment of a nano-material.

FIG. 9 is an SEM image of the nano-material of FIG. 8.

FIG. 10 is a schematic view of a third embodiment of a nano-material.

FIG. 11 is a process flow chart of one embodiment of a method for fabricating the nano-material of FIG. 10.

FIG. 12 is an SEM image of the third embodiment of a nano-material.

FIG. 13 is a schematic view of a fourth embodiment of a nano-material.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

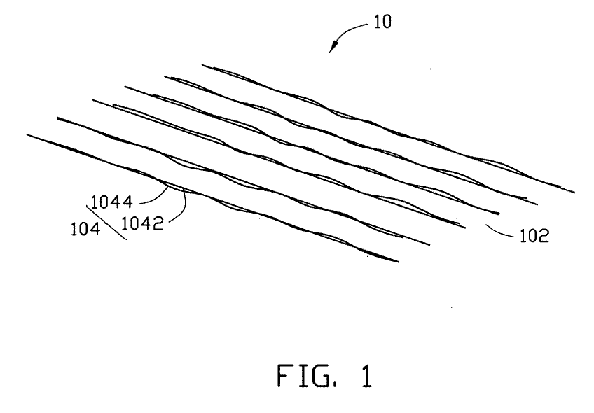

Referring to FIG. 1, in a first embodiment, a nano-material 10 includes a carbon nanotube composite film structure 102. The carbon nanotube composite film structure 102 includes a plurality of carbon nanotube composite nanowires 104 adhered to each other by van der Waals attractive forces to form a free-standing structure. The carbon nanotube composite nanowires 104 are substantially parallel with each other and aligned along one preferred orientation.

The free-standing carbon nanotube structure means the carbon nanotube composite film structure 102 can maintain a certain shape without any additional support, unlike a powder or liquid form. Since the carbon nanotube composite film structure 102 includes a plurality of carbon nanotube composite nanowires 104 combined by van der Waals attractive force therebetween, the certain shape can maintain.

Each carbon nanotube composite nanowire 104 can extend from one end of the carbon nanotube composite film structure 102 to the opposite end of the carbon nanotube composite film structure 102. Two adjacent carbon nanotube composite nanowires 104 of the carbon nanotube composite film structure 102 can be in contact with each other and joined together via van der Waals attractive force, or there can be a gap between two adjacent carbon nanotube composite nanowires 104. In this embodiment a distance between the two adjacent carbon nanotube composite nanowires 104 can be from about 0.5 nanometers (nm) to about 100 micrometers (μm). Each of the carbon nanotube composite nanowires 104 can be made of at least one carbon nanotube 1042 and a plurality of nano-particles successively distributed on the surface of the carbon nanotube 1042. The nano-particles are joined together via van der Waals attractive force therebetween or chemical bonding. In one embodiment, each of the carbon nanotube composite nanowires 104 includes a plurality of carbon nanotubes 1042 orderly arranged along a lengthwise direction of the carbon nanotube composite nanowire 104. The carbon nanotubes 1042 of the carbon nanotube composite nanowire 104 can be single-walled, double-walled, or multi-walled carbon nanotubes. A diameter of each single-walled carbon nanotube ranges from about 0.5 nm to about 50 nm. A diameter of each double-walled carbon nanotube ranges from about 1 nm to about 50 nm. A diameter of each multi-walled carbon nanotube ranges from about 1.5 nm to about 50 nm. The length of each carbon nanotube is above 50 μm. In one embodiment, lengths of the carbon nanotubes 1042 can range from about 200 μm to about 900 μm. A length of the carbon nanotube composite nanowire 104 is larger than 1 centimeter (cm).

Thickness of the carbon nanotube composite film structure 102 ranges from about 0.5 nm to about 100 μm. The carbon nanotube composite film structure 102 can include at least one carbon nanotube film. It is understood that any carbon nanotube composite film structure 102 described can be used in any embodiment.

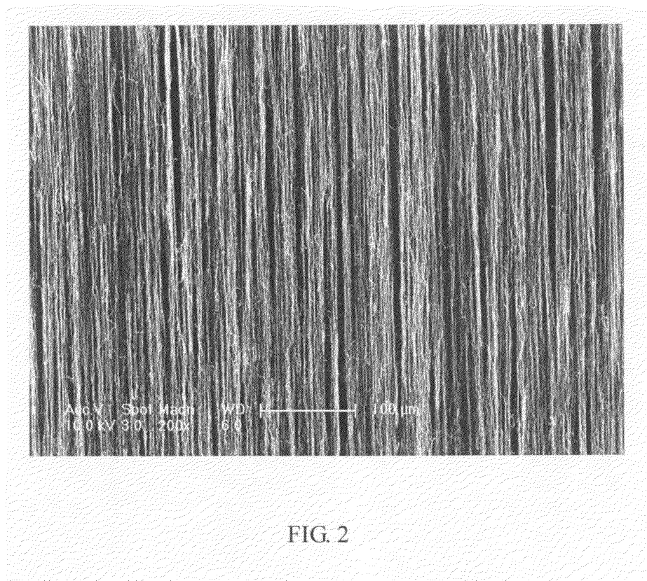

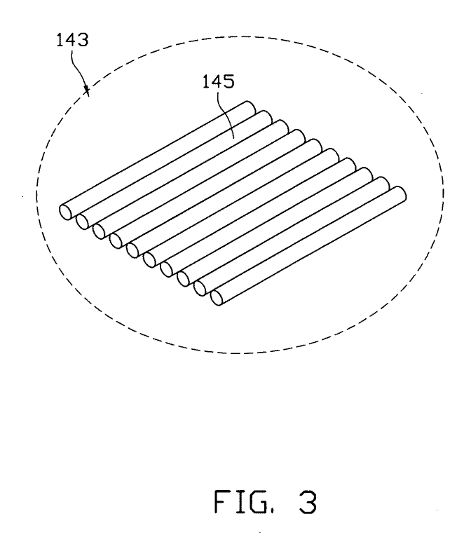

In one embodiment, the carbon nanotube composite film structure 102 includes at least one drawn carbon nanotube film. A film can be drawn from a carbon nanotube array, to form a drawn carbon nanotube film. Examples of drawn carbon nanotube film are taught by U.S. Pat. No. 7,045,108 to Jiang et al., and WO 2007015710 to Zhang et al. The drawn carbon nanotube film includes a plurality of successive and oriented carbon nanotubes joined end-to-end by van der Waals attractive force therebetween. The drawn carbon nanotube film is a free-standing film. Referring to FIGS. 2 to 3, each drawn carbon nanotube film includes a plurality of successively oriented carbon nanotube segments 143 joined end-to-end by van der Waals attractive force therebetween. Each carbon nanotube segment 143 includes a plurality of carbon nanotubes 145 substantially parallel to each other, and combined by van der Waals attractive force therebetween. The carbon nanotubes 145 in the drawn carbon nanotube film are substantially oriented along a preferred orientation. The carbon nanotube film can be treated with an organic solvent to increase the mechanical strength and toughness of the carbon nanotube film and reduce the coefficient of friction of the carbon nanotube film. A thickness of the carbon nanotube film can range from about 0.5 nm to about 100 μm.

A method of making a drawn carbon nanotube film includes the steps of: providing an array of carbon nanotubes; and pulling out a drawn carbon nanotube film from the array of carbon nanotubes using a tool such as adhesive tape, pliers, tweezers, or other tools allowing multiple carbon nanotubes to be gripped and pulled simultaneously.

The drawn carbon nanotube film can be formed by selecting one or more carbon nanotubes having a predetermined width from the array of carbon nanotubes and pulling the carbon nanotubes at a uniform speed to form carbon nanotube segments that are joined end to end to achieve a uniform drawn carbon nanotube film.

The carbon nanotube segments can be selected by using the tool allowing multiple carbon nanotubes to be gripped and pulled simultaneously to contact with the array of carbon nanotubes. The pulling direction can be substantially perpendicular to the growing direction of the array of carbon nanotubes.

More specifically, during the pulling process, as the initial carbon nanotube segments are drawn out, other carbon nanotube segments are also drawn out end to end due to van der Waals attractive forces between ends of adjacent segments. This process of pulling produces a substantially continuous and uniform carbon nanotube film having a predetermined width.

The nano-particles are successively distributed on the surface of each of the carbon nanotubes 1042 of the carbon nanotube composite nanowire 104. The adjacent nano-particles are successive and closely linked to each other to from a nanowire 1044. An effective diameter of each of the nano-particles is in a range from about 1 nm to about 500 nm. In one embodiment, the effective diameter of the nano-particle is in a range from about 1 nm to about 150 nm. Each of the nano-particles wraps part of the surface of at least one carbon nanotube 1042. When the size of the carbon nanotube 1042 is smaller than that of the nano-particle, the whole carbon nanotube 1042 is totally wrapped by the nano-particle. The carbon nanotubes 1042 can also be bundled together to form a plurality of carbon nanotube bundles. The nano-particles are successively coated on the surface of the carbon nanotube bundle and arranged along the length direction of the carbon nanotube bundle. The nano-particles and the carbon nanotube 1042 are attracted by chemical bond and van der Waals attractive force. The nano-material 10 has a large specific surface area because the carbon nanotube composite nanowires 104 have gaps therebetween.

The nano-particles can be metal nano-particles, non-metal nano-particles, alloy nano-particles, metallic oxide nano-particles, polymer nano-particles, and any combination thereof. The metallic oxide nano-particles include titanium dioxide (TiO₂), zinc oxide (ZnO), nickel oxide (NiO), aluminum oxide (Al₂O₃), and any combination thereof. In one embodiment, the nano-particle is TiO₂. The shape of the nano-particles can be a sphere, a spheroid, and any combination thereof. The carbon nanotube composite nanowires 104 can be substantially parallel to each other. At least one carbon nanotube 1042 of the carbon nanotube composite nanowire 104 is embedded in one nano-particle.

The nano-material 10 of the present embodiment has many advantages. Firstly, the nano-material 10 has a large specific surface because the carbon nanotubes have gaps therebetween. The nano-material 10 which has a large specific surface can be used as a good catalyst. Secondly, the nano-particles are uniformly distributed on the carbon nanotube composite film structure 102 to prevent the nano-particles from agglomerating. In addition, the nano-material 10 is a free-standing structure because the carbon nanotube composite film structure 102 is a free-standing structure.

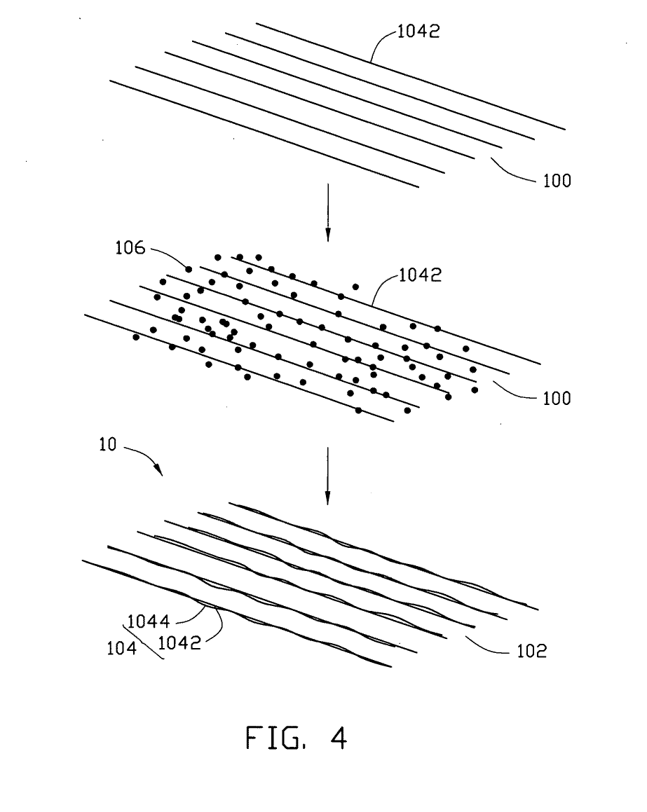

Referring to FIG. 4, one embodiment of a method for making the nano-material 10 includes:

(1) providing at least one free-standing carbon nanotube film 100 having a plurality of carbon nanotubes substantially aligned along the same direction;

(2) introducing at least two types of reacting materials 106 into the carbon nanotube film 100; and

(3) activating the reacting materials 106 to obtain a carbon nanotube composite film structure 102.

In step (1), the carbon nanotube film 100 includes a plurality of carbon nanotubes 1042 adhered to each other by the van Der Waals attractive force to form a free-standing structure. The carbon nanotubes 1042 in the carbon nanotube film 100 are substantially oriented along the same orientation. In one embodiment, the carbon nanotube film 100 is a drawn carbon nanotube film described above.

In other embodiment, the carbon nanotube film 100 includes a plurality of carbon nanotubes 1042 substantially parallel with each other. Each of the carbon nanotubes 1042 extends from one end of the carbon nanotube film 100 to the other end of the carbon nanotube film 100. Examples of the carbon nanotube film 100 are taught by US2009/0197038A1 to Wang et al.

Furthermore, the carbon nanotube film 100 can be adhered to a frame or on a substrate directly. In one embodiment, two drawn carbon nanotube films are located on a metal substrate and the carbon nanotubes in the two drawn carbon nanotube film are substantially oriented along the same orientation.

In step (2), the reacting materials 106 can be solid, liquid, or gaseous.

One method for introducing the at least two types of reacting materials 106 into the carbon nanotube film 100 includes (2a1) introducing a first reacting material to form a first reacting material layer on the surface of the carbon nanotube film 100, and (2a2) introducing a second reacting material to the carbon nanotube film 100.

In step (2a1), the thickness of the first reacting material layer is about 50 nm to about 100 nm. The material of the first reacting material is dependent on the material of the nano-particle to be prepared. The first reacting material can be a metal, non-metal, semiconductor, and any combination thereof as desired. In one embodiment, the first reacting material is metal, for example, titanium (Ti), aluminum (Al), or nickel (Ni), and metal compound nano-particles, for example, metal oxide or metal silicide. The nano-particle structure can be obtained by introducing the first reacting material. In one embodiment, the first reacting material is silicon and a non-metal compound, for example, silicon nitride or silicon carbide nanostructure can be obtained by introducing the first reacting material.

The method for forming the first reacting layer can be chemical vapor deposition (CVD), physical vapor deposition (PVD), impregnation method, spraying method, or silk-screen printing method. The metal or metal oxide can be sputtered on the surface of the carbon nanotube film 100 by the PVD method. The non-metallic nitride or carbide can be formed on the surface of the carbon nanotube film 100 by the CVD method. The metal organic solution can be formed on the surface of the carbon nanotube film 100 by the methods of impregnation, spraying, or silk-screen printing. Part or all the surface of the carbon nanotube film 100 can be coated with the first reacting materials.

In step (2a2), the second reacting material can be liquid or gaseous. The gaseous second reacting material can be oxygen gas, nitrogen gas, silicon source gas and carbon source gas, and any combination thereof. The method of introducing the gaseous second reacting material is directly introducing the gaseous second reacting material into a chamber having a carbon nanotube structure deposited thereon. The gaseous second reacting material is distributed on the surroundings of the carbon nanotube film 100 and the first reacting material.

The second reacting material can also be in liquid form such as methanol, ethanol, acetone, liquid resin, and any combination thereof. The method of introducing the liquid second reacting material is by directly dropping the liquid second reacting material on the surface of the carbon nanotube film 100 or immersing the carbon nanotube film 100 in the liquid reacting material. The liquid second reacting material is distributed on the surroundings of the carbon nanotube film 100 and the first reacting material.

Another method for introducing the at least two types of reacting materials into the carbon nanotube film 100 includes (2b1) forming a first reacting material layer on the surface of the carbon nanotube film 100 and (2b2) forming a second reacting material layer on the surface of the first reacting material layer. The total thickness of the first and the second reacting material layers is about 50 nm to about 100 nm. In one embodiment, the first reacting material layer is a metal layer, for example, an Al and Ti layer, and the second reacting material layer is a silicon layer. In one embodiment, the first and the second reacting layer are metal layers, for example, an Al and Ti layer or an Al and Ni layer.

Yet another method for introducing the at least two types reacting materials into the carbon nanotube film 100 includes simultaneously introducing two gaseous reacting materials, two liquid reacting materials, or a combination of one gaseous reacting material and one liquid reacting material.

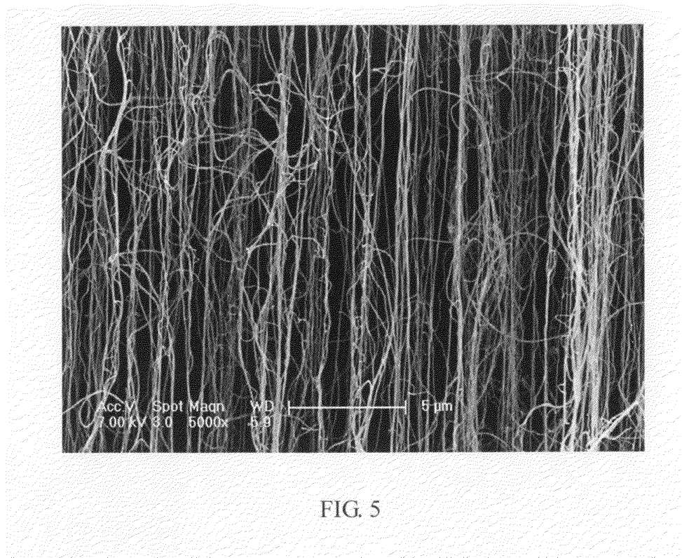

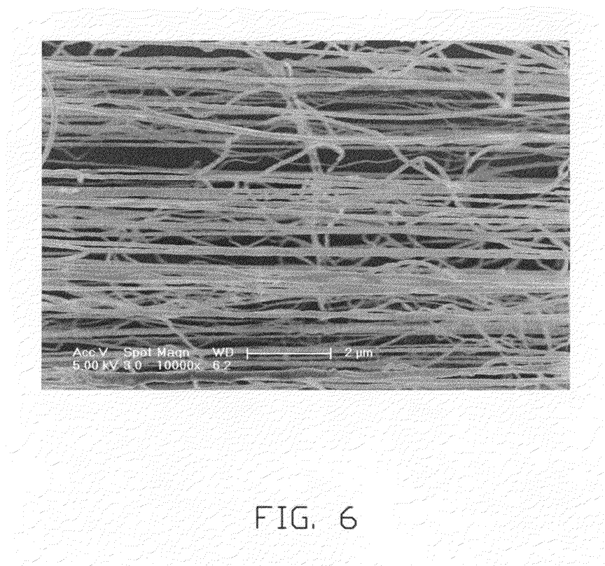

Referring to FIG. 5, a Ti layer is deposited on the surface of the carbon nanotube film 100 by a magnetron sputtering method. The carbon nanotube film 100 with the Ti layer is exposed to the atmosphere, thus creating a sufficient contact between the Ti particles on the surface of the carbon nanotube structure and the oxygen gas in the atmosphere. When the thickness of the Ti layer reaches about 1 nm to about 50 nm, a plurality of titanium dioxide (TiO₂) nano-particles is formed after the reaction of the Ti layer and the oxygen gas. Referring to FIG. 6, when the thickness of the Ti layer is larger than 50 nm, a plurality of successive TiO₂ nano-wires can be formed.

In step (3), the reacting materials 106 are activated to grow nano-particles. The methods of activating the reacting materials 106 can be by heating, laser scanning, reactive sputtering and any combination thereof. The gas containing a silicon source and a carbon source is activated to grow silicon carbide nano-particles by the heating method. The metal and oxygen gas are activated to grow metallic oxide nano-particles by the laser irradiating method. Vacuum sputtering of metal particles and oxygen gas grows metal oxide nano-particles.

In one embodiment, the laser scanning is used to render the reacting materials 106 to react. When the total surface of the carbon nanotube film 100 is scanned via the laser scanning method, the reacting materials 106 on the surface of the carbon nanotube film 100 can be reacted. When a part of the surface of the carbon nanotube film 100 is scanned via the laser scanning method, the reacting materials on the surface of the carbon nanotube film 100 diffuse along the arrangement of the carbon nanotubes from the position where the laser is scanned.

When the part of the surface of the carbon nanotube film 100 is scanned, the carbon nanotube structure can be arranged on a substrate. The larger the heat transfer coefficient, the faster the heat transfer toward the substrate and the slower the growth speed of the carbon nanotube film 100. If the carbon nanotube film 100 is suspended on the frame, the carbon nanotube film 100 has the fastest heat transfer because of a small coefficient of the air.

Nano-particles are coated on the surface of the carbon nanotube film 100 and grow along the length direction of the carbon nanotubes 1042 of the carbon nanotube film 100. The nano-material 10 is free-standing because the carbon nanotube film 100 utilized as the template is free-standing.

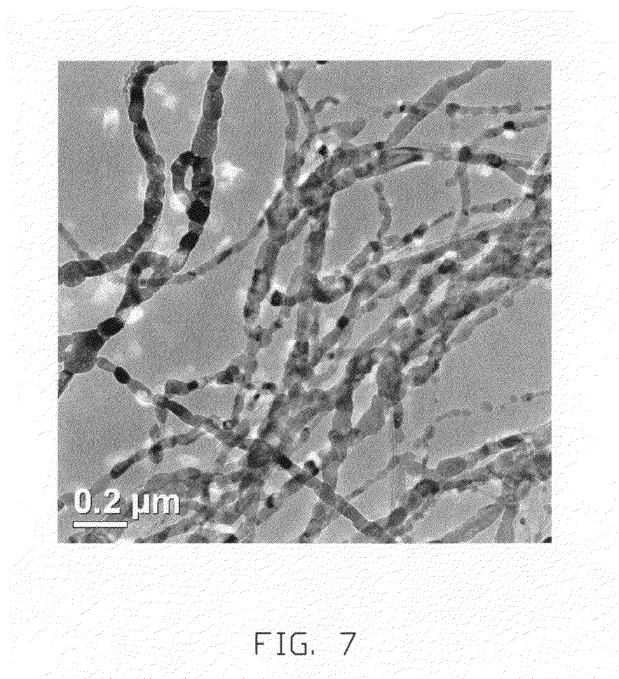

The nano-material 10 includes a carbon nanotube film 100 and a plurality of uniformly distributed TiO₂ nano-particles. The size distribution of the TiO₂ nano-particles diameter change with the Ti layer thickness. If the layer thickness is sufficiently small, the sizes of the nano-particles diameter are more uniformly distributed. Referring to FIG. 7, a TEM image of the nano-material 10 of FIG. 6, a plurality of carbon nanotubes are embedded in one TiO₂ nano-particle.

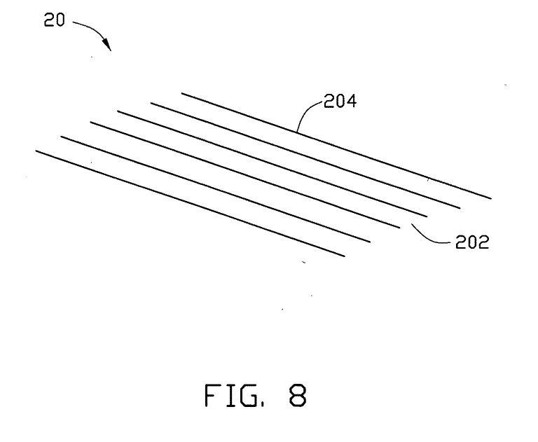

Referring to FIG. 8, in a second embodiment, a nano-material 20 includes a nano-sized film structure 202. The nano-sized film structure 202 includes a plurality of nanowires 204 adhered to each other and together by van der Waals attractive forces to form a free-standing structure. The nanowires 204 are substantially aligned along one preferred orientation

The free-standing nano-sized film structure 202 means the nano-sized film structure 202 can maintain a certain shape without any external support, unlike a powder or liquid form, since the nano-sized film structure 202 includes the plurality of nanowires 204 combined by van der Waals attractive force therebetween. The nanowires 204 are made of a plurality of nano-particles uniformly arranged along a lengthwise direction of the nanowires 204. The nano-sized film structure 202 has a thickness ranging from about 0.5 nm to about 100 μm. The adjacent nano-particles are successive and closely linked to each other to form a nanowire 204.

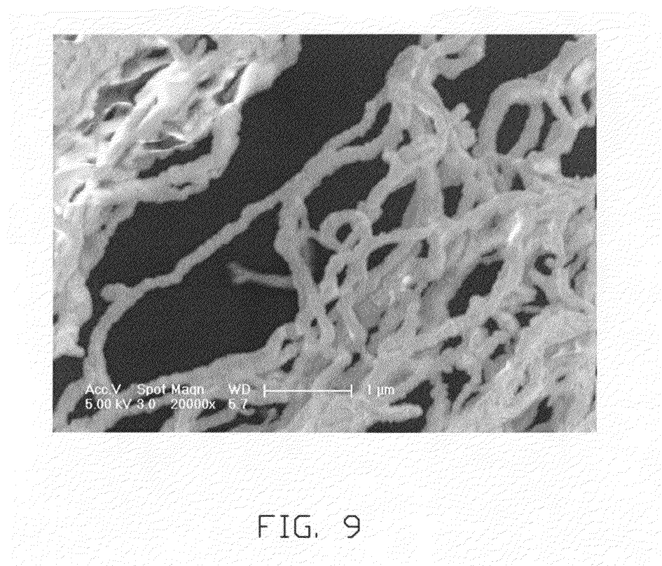

Referring to FIG. 9, the nanowire 204 can be separated from the nano-material 10. The method of separating the nanowire 204 from the nano-material 10 depends on the material of the nanowire 204. The carbon nanotube structure can be removed to form non-metallic nitrides nanowire and metallic oxide nanowire by a high-temperature oxidation process. In one embodiment, the carbon nanotubes are removed by exposing the nano-material 10 to heat at a temperature of about 500° C. to about 1000° C. for about 1 hour to about 4 hours.

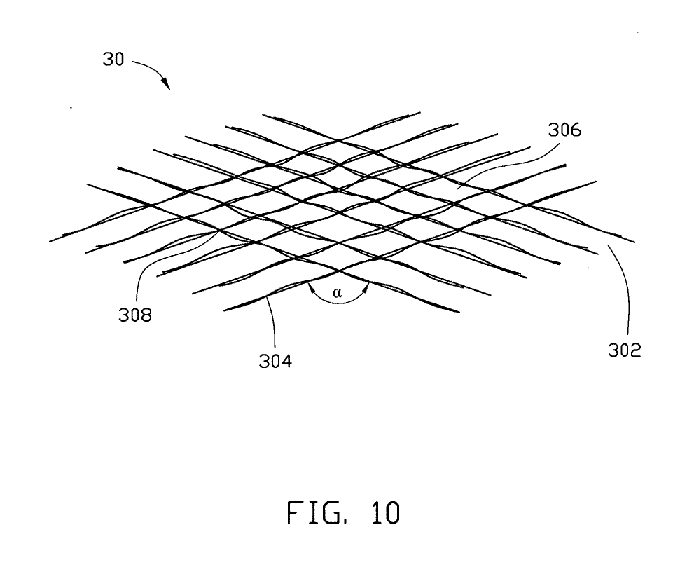

Referring to FIG. 10, in a third embodiment, a nano-material 30 includes at least two stacked carbon nanotube composite film structures 302. The carbon nanotube composite film structures 302 and the carbon nanotube composite film structure 102 have the same structure. Additionally, when the carbon nanotubes in the carbon nanotube composite film structures 302 are substantially aligned along one preferred orientation (e.g., the drawn carbon nanotube film), an angle can exist between the orientation of carbon nanotubes in adjacent films. The number of the layers of the carbon nanotube composite film structures 302 is not limited. However, as the thickness of the carbon nanotube composite film structures 302 increases, the specific surface area decreases. An angle between the aligned directions of the carbon nanotubes in two adjacent carbon nanotube composite film structures 302 can range from about 0 degrees to about 90 degrees. When the angle between the aligned directions of the carbon nanotubes in adjacent carbon nanotube films is greater than 0 degrees, a microporous structure 306 is defined by the carbon nanotube composite nanowires 304. The carbon nanotube composite nanowires 304 employing these films will have a plurality of micropores 306 and joints 308. Each of the micropores 306 has a diameter which can range from about 1 nm to about 5 μm. Stacking the carbon nanotube composite film structures 302 will also add to the structural integrity of the carbon nanotube structure.

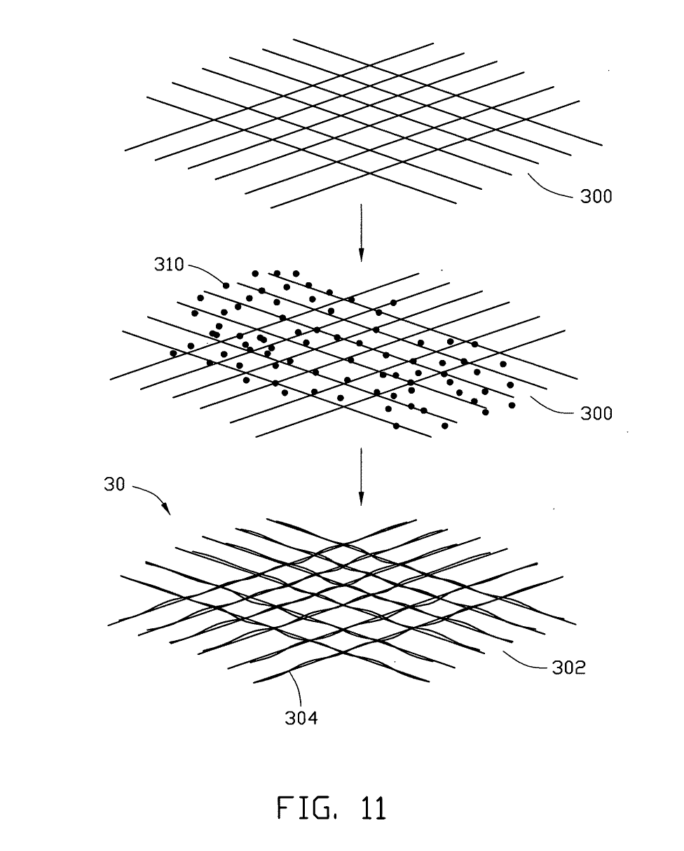

Referring to FIG. 11, in another embodiment, a method for making the nano-material 30 includes:

(1) providing more than one free-standing stacked carbon nanotube films 300;

(2) introducing at least two types of reacting materials 310 into the stacked carbon nanotube films 300; and

(3) activating the reacting materials 310, to obtain a carbon nanotube composite film structure 302.

In step (1), each of the carbon nanotube films 300 is the carbon nanotube film 100. Adjacent carbon nanotube films 300 are substantially perpendicular to each other and combined only by the van der Waals attractive force therebetween.

The stacked carbon nanotube films 300 can be adhered to a frame or on a substrate directly. In one embodiment, the stacked carbon nanotube film 300 can be stacked side by side substantially parallel to each other on a metal frame.

In step (2), the reacting materials 310 can be solid, liquid, or gaseous.

One method for introducing the at least two types of reacting materials 310 into the stacked carbon nanotube films 300 includes (2a1) introducing a first reacting material to form a first reacting material layer on the surface of the stacked carbon nanotube film 300, and (2a2) introducing a second reacting material to the stacked carbon nanotube film 300. The method is the same as the method as mentioned above, therefore, the detailed description is omitted.

In step (3), the reacting materials 310 are activated to grow nano-particles. The method of activating the reacting materials 310 is by laser scanning. The laser has a power density of about 0.4 to about 10 watts and a self-diffusing speed larger 10 mm/s. The detailed description of the method of reacting materials 310 into the stacked carbon nanotube film 300 is omitted because it is same as mentioned above.

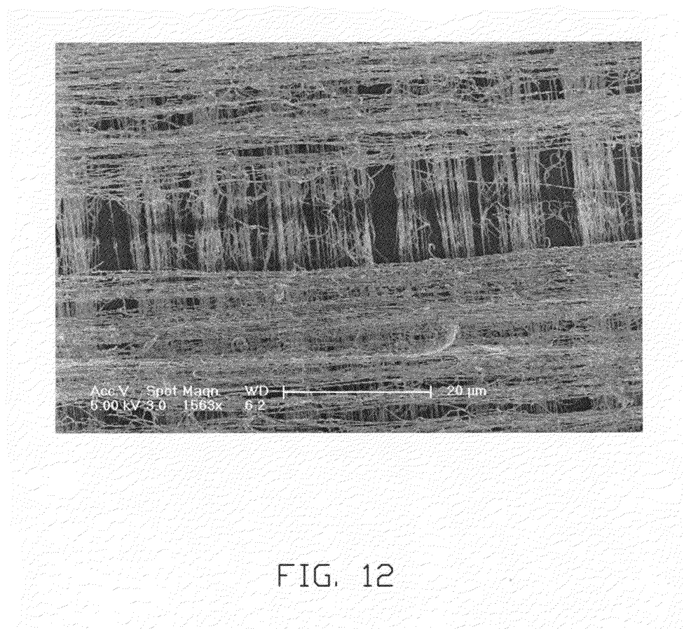

Referring to FIG. 12, the stacked carbon nanotube film 300 with the Ti layer is exposed to the atmosphere, thus creating a sufficient contact between the Ti particles on the surface of the stacked carbon nanotube film 300 and the oxygen gas in the atmosphere. When the thickness of the Ti layer reaches about 1 nm to about 50 nm, a plurality of successive titanium dioxide (TiO₂) nano-particles is formed after the reaction of the Ti layer and the oxygen gas. When the thickness of the Ti layer is larger than 50 nm, a plurality of successive TiO₂ nano-wires can be formed.

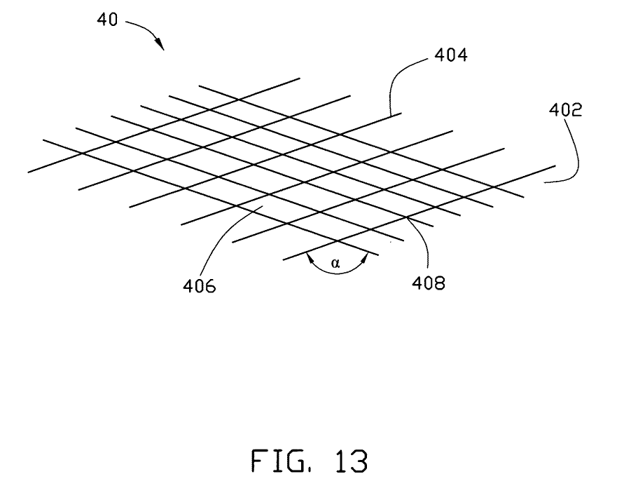

Referring to FIG. 13, in a fourth embodiment, a nano-material 40 includes a plurality of nano-sized film structures 402. The nano-sized film structures 402 and the nano-sized film structures 202 have the same structure. The nano-sized film structures 402 includes a plurality of nanowires 404 adhered to each other by van der Waals attractive forces to form a free-standing structure. The nanowires 404 are substantially aligned along one preferred orientation. An angle between the aligned directions of the adjacent nanowires 404 can range from about 0 degrees to about 90 degrees. When the angle between the aligned directions of the adjacent nanowires 404 is greater than 0 degrees, a microporous structure 406 is defined by the nanowires 404. The nanowires 404 in an embodiment employing these films will have a plurality of micropores 406 and joints 408. A diameter of the micropores 406 can range from about 1 nm to about 0.5 μm. Stacking the carbon nanotube films will also add to the structural integrity of the carbon nanotube structure.

The method of introducing reacting materials 106, 310 into the single carbon nanotube films 100 and stacked carbon nanotube films 300, and then activating the reacting materials 106, 310 to grow the nano-material 10, 30 is thus easy, has a low cost, and is suitable for mass production.

Finally, it is to be understood that the embodiments described are intended to illustrate rather than limit the present disclosure. Variations may be made to the embodiments without departing from the spirit of the present disclosure as claimed. The embodiments illustrate the scope of the present disclosure but do not restrict the scope of the disclosure.

What is claimed is:

1. A nano-material comprising:
a free-standing carbon nanotube structure comprising a plurality of carbon nanotubes; and
a plurality of nano-particles successively and closely linked to each other and coated on a surface of each of the carbon nanotubes.

2. The nano-material as claimed in claim 1, wherein an effective diameter of each of the nano-particles is in a range from about 1 nanometer to about 500 nanometers.

3. The nano-material as claimed in claim 1, wherein the nano-particles are selected from the group consisting of metal nano-particles, non-metal nano-particles, alloy nano-particles, metallic oxide nano-particles, polymer nano-particles, and any combination thereof.

4. The nano-material as claimed in claim 1, wherein each of the nano-particles is adhered to a surface of at least one carbon nanotube.

5. The nano-material as claimed in claim 1, wherein each of the nano-particles wraps a part of a surface of at least one carbon nanotube.

6. The nano-material as claimed in claim 1, wherein each carbon nanotube is totally wrapped by one of the nano-particles if each carbon nanotube is smaller than each nano-particle.

7. The nano-material as claimed in claim 1, wherein the carbon nanotube structure is a drawn carbon nanotube film comprising a plurality of carbon nanotubes substantially oriented along a direction and joined end to end.

8. The nano-material as claimed in claim 1, wherein the carbon nanotube structure is a stacked carbon nanotube film structure comprising at least two carbon nanotube films stacked side by side.

9. A nano-material comprising:
a free-standing film structure comprising at least one nano-sized film structure, wherein the at least one nano-sized film structure comprises a plurality of nanowires combined by van der Waals attractive force therebetween and substantially aligned along one preferred orientation.

10. The nano-material as claimed in claim 9, each of the nanowires is formed by a plurality of nano-particles successively and closely linked to each other.

11. The nano-material as claimed in claim 10, wherein the nano-particles are selected from the group consisting of metal nano-particles, non-metal nano-particles, alloy nano-particles, metallic oxide nano-particles, polymer nano-particles, and any combination thereof.

12. The nano-material as claimed in claim 9, wherein the free-standing film structure is a stacked nano-sized film structure comprising at least two nano-sized film structures stacked side by side.

13. The nano-material as claimed in claim 12, a plurality of micropores and joints are defined by the stacked nano-sized film structure.

14. A nano-material comprising:
a carbon nanotube composite film structure comprising a plurality of carbon nanotube composite nanowires adhered to each other and together by van der Waals attractive forces to form a free-standing structure.

15. The nano-material as claimed in claim 14, wherein the plurality of carbon nanotube composite nanowires are substantially parallel with each other and aligned along one preferred orientation.

16. The nano-material as claimed in claim 15, wherein each of the carbon nanotube composite nanowires extends from one end of the carbon nanotube composite film structure to an opposite end of the carbon nanotube composite film structure.

17. The nano-material as claimed in claim 15, wherein two adjacent carbon nanotube composite nanowires are separated apart from each other.

18. The nano-material as claimed in claim 15, wherein two adjacent carbon nanotube composite nanowires contact each other.

19. The nano-material as claimed in claim 14, wherein each of the carbon nanotube composite nanowires is made of at least one carbon nanotube and a plurality of nano-particles successively distributed on the surface of carbon nanotube.

20. The nano-material as claimed in claim 14, wherein each of the carbon nanotube composite nanowires comprises a plurality of carbon nanotubes orderly arranged along a lengthwise direction of the carbon nanotube composite nanowire.
